(19) United States
(12) Patent Application Publication
(10) Pub. No.: US 2014/0335484 A1
(43) Pub. Date: Nov. 13, 2014

(54) Method Of Teaching Multiplication To Mathematics Students

(71) Applicant: Mohammad Gheith, Oak Lawn, IL (US)

(72) Inventor: Mohammad Gheith, Oak Lawn, IL (US)

(21) Appl. No.: 14/269,124

(22) Filed: May 3, 2014

Related U.S. Application Data
(60) Provisional application No. 61/822,876, filed on May 13, 2013.

(51) Int. Cl. G09B 23/02

(52) U.S. Cl. CPC G09B 23/02
USPC 434/191

(57) ABSTRACT

A method of teaching multiplication comprises the steps of providing a pair of multi-digit numbers to be multiplied and diagrammatically arranging the numbers on a work area. The work area includes a Multiplication Zone, an Addition Zone and an Answer Zone. In the Multiplication Zone, the numbers are arranged such that the digits of one number are vertically aligned with the digits of the other number. The Addition Zone has a top row, a bottom row and a plurality of middle rows, with the rows divided into a number of columns. The Answer Zone consists of a row divided into a number of cells. The products of multiplication and cross-multiplication of the aligned digits can be placed in a designated columns and cells in the Addition Zone and Answer Zone such that the sequence of digits in the Answer Zone is the product of the multiplication of the pair of multi-digit numbers.

### CROSS-REFERENCE TO RELATED APPLICATION

This application relates to and claims priority benefits from U.S. Provisional Patent Application Ser. No. 61/822,876 having a filing date of May 13, 2013. The '876 provisional application is hereby incorporated by reference herein in its entirety.

### FIELD OF INVENTION

The present invention relates to the field of mathematics and, in particular, to a method of teaching multiplication to mathematics students

### BACKGROUND OF THE INVENTION

Students acquire analytical skills in different ways. For many students, traditional methods of teaching mathematics skills, such as multiplication and division, are not as effective as other less conventional, and perhaps previously overlooked, methods. It is therefore beneficial to have available a portfolio of methods for teaching a given mathematics skill so that a teacher working with a student having difficulty in acquiring the skill using one method can turn to a different method that may be better suited to the student's way of learning.

In the case of multiplication of multi-digit numbers, the conventional method involves arranging the digits in columns and keeping track of how many places to proceed to the left as multiplications of individual digits are performed. With larger multi-digit numbers, this conventional method can get confusing as it is easy to lose track of how many places to the left to arrange the product of each of the two digits being multiplied. Carrying numbers can also be confusing because numbers arranged in columns at the top can get confused as multiple numbers are being carried and arranged on top of the same digit in the original number. Mistakes are also hard to find in this conventional method when so many digits need to be carefully arranged in proper columns. Adding up the rows of digits at the end of the conventional method is an extra step that can be subject to error as well.

The present method of teaching multiplication provides an alternative approach to multiplying multi-digit numbers that can be understood by students who struggle with conventional multiplication techniques. The present method is particularly effective for teaching multiplication of large multi-digit numbers.

### SUMMARY OF THE INVENTION

A method of teaching multiplication to mathematics students, the method comprising the steps of:
(a) providing a pair of multi-digit numbers to be multiplied;
(b) diagrammatically arranging the numbers on a work area comprising:
(1) a Multiplication Zone comprising the numbers arranged such that the digits of one number are vertically aligned with the digits of the other number;
(2) an Addition Zone comprising a top row, a bottom row and a plurality of middle rows, the rows divided into a number of columns corresponding to the sum of the number of digits in the numbers to be multiplied minus one;
(3) an Answer Zone comprising a row divided into a number of cells corresponding to the sum of the number of digits in the numbers to be multiplied minus one;
(c) establishing a pivot point beneath the aligned lowest place digits;
(d) multiplying the aligned lowest place digits and cross-multiplying the aligned digits on either side of the pivot point progressively in pairs until no further pairs can be formed;
(e) placing the products of multiplication step (d) in the middle rows of the right-most empty column of the Addition Zone;
(f) adding together the products placed in the column of step (e) and placing the sum in the right-most empty cell in the bottom row of the Addition Zone;
(g) placing the lowest place digit of the sum in step (f) in the right-most empty cell of the Answer Zone and placing the higher place digits of the sum in step (f) in the next cell to the left in the top row of the Addition Zone;
(h) establishing a next pivot point between the aligned lowest and next-lowest place digits;
(i) cross-multiplying the aligned digits on either side of the pivot point progressively in pairs until no further pairs can be formed;
(j) placing the product of the cross-multiplication step (i) in the middle rows of the right-most empty column of the Addition Zone;
(k) adding together the products placed in the column of step (j) and placing the sum in the right-most empty cell in the bottom row of the Addition Zone;
(l) placing the lowest place digit of the sum in step (k) in the right-most empty cell of the Answer Zone and placing the higher place digits of the sum in step (k) in the next cell to the left in the top row of the Addition Zone;
(m) repeating steps (c) through (l) until the left-most aligned digits have been multiplied.

The sequence of digits in the Answer Zone is the product of the multiplication of the pair of multi-digit numbers.

In the foregoing method, when the multi-digit numbers are of different length, the numbers are made equal in length by preceding the smaller number with zeroes.

A diagrammatic work area for teaching multiplication to mathematics students, the work area comprising:
(a) a Multiplication Zone comprising a pair of multi-digit numbers to be multiplied arranged such that the digits of one number are vertically aligned with the digits of the other number;
(b) an Addition Zone comprising a top row, a bottom row and a plurality of middle rows, the rows divided into a number of columns corresponding to the sum of the number of digits in the numbers to be multiplied minus one;
(c) an Answer Zone comprising a row divided into a number of cells corresponding to the sum of the number of digits in the numbers to be multiplied minus one;

such that:
(1) each of the products of multiplication and cross-multiplication of the aligned digits can be placed in a designated column in the middle rows of the Addition Zone;
(2) each of the sums resulting from the addition of the products in the columns can be placed in a right-most empty cell of the bottom row of the Addition Zone;
(3) each of the lowest place digits of the sums can be placed in a right-most empty cell of the Answer Zone and each of the higher place digits of the sums can be placed in the next cell to the left in the top row of the Addition Zone; and
(4) the sequence of digits in the Answer Zone is the product of the multiplication of the pair of multi-digit numbers.

### BRIEF DESCRIPTION OF THE DRAWINGS

FIG. 1A (Prior Art) is a diagram showing the conventional method of teaching the multiplication of two single-digit numbers to mathematics students.

FIG. 1B (Prior Art) is a diagram showing the conventional method of teaching the multiplication of two single-digit numbers in which the work area is divided into zones to facilitate the steps involved in the method.

FIG. 2A (Prior Art) is a diagram showing the conventional method of teaching the multiplication of two double-digit numbers to mathematics students.

FIG. 2B (Prior Art) is a diagram showing the conventional method of teaching the multiplication of two double-digit numbers in which the work area is divided into zones to facilitate the steps involved in the method.

FIGS. 3A-3J are diagrams showing the progression of steps involved in the present method of teaching the multiplication of two 5-digit numbers, made up of the numbers 1 and 2 for simplicity, in which the work area is divided into zones to facilitate the steps involved in the method.

FIGS. 4A-4J are diagrams showing the progression of steps involved in the present method of teaching the multiplication of two 5-digit numbers, made up of larger numbers than those in FIGS. 3A-3J, in order to demonstrate the present method using numbers whose products when multiplied are larger double-digit numbers.

FIGS. 5A-5N are diagrams showing the progression of steps involved in the present method of teaching the multiplication of two 7-digit numbers.

### DETAILED DESCRIPTION OF PREFERRED EMBODIMENT(S)

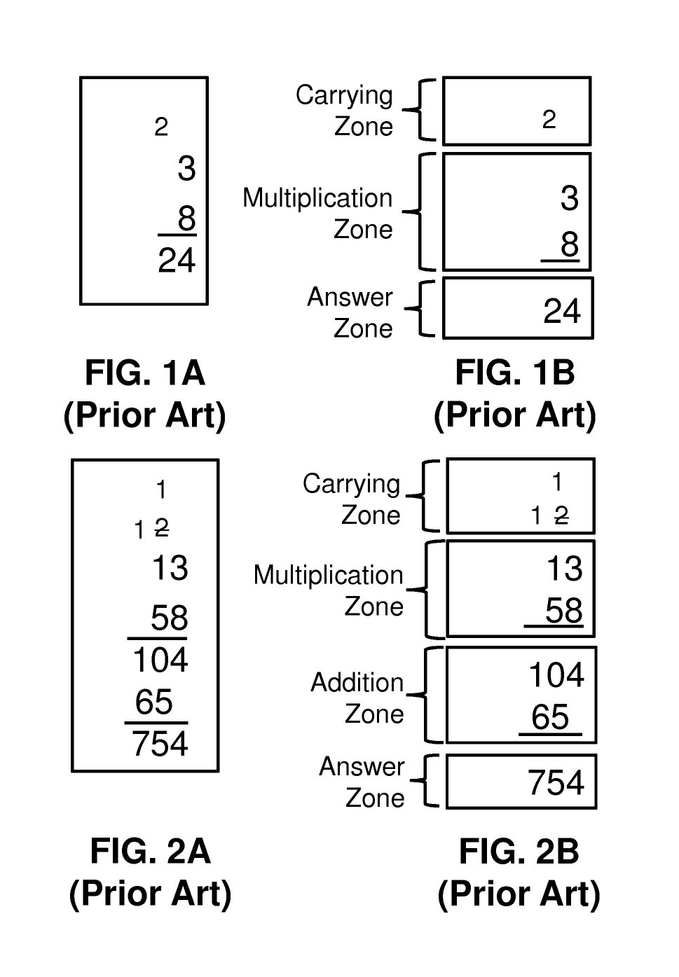

Turning first to FIG. 1A, the conventional method of teaching multiplication involves first arranging the digits of the numbers to be multiplied in columnar fashion with a line drawn beneath the lower number. The digits in the right-most column are multiplied to produce a product (24), which the student doing the multiplication must keep in mind. The ones-place (right-most) digit of the product (4 in the case of FIG. 1A) is placed in columnar fashion beneath the line and the tens-place or left-most digit is placed above the second column of numbers being multiplied. In the case of the single-digit numbers being multiplied in FIG. 1A, there are no digits in the second column, so the tens-place digit placed above that column is simply “added” together with assumed zeroes in the second column to produce a sum (2 in the case of FIG. 1A), which is then placed in columnar fashion beneath the line to produce the result of the multiplication, namely, 24.

FIG. 1B shows in diagrammatic form the multiplication method described above with reference to FIG. 1A. In FIG. 1B, the work area is divided into a Multiplication Zone, a Carrying Zone and an Answer Zone, which correspond to and, once drawn, facilitate the steps involved in the multiplication method.

Turning to FIGS. 2A and 2B, the conventional method of teaching multiplication is demonstrated for two double-digit numbers. Once arranged in columnar fashion in the Multiplication Zone as shown in FIG. 2B, the ones-place (right-most) digits (3 and 8) are multiplied to produce a product (24). The ones-place digit (4) of the product is placed in columnar fashion in the first column of the Addition Zone beneath the line at the bottom of the Multiplication Zone. The tens-place digit (2) of the product is placed in the Carrying Zone above the second column of digits in the Multiplication Zone. Next, the ones-place digit (8) in the lower number and the tens-place digit (1) of the upper number are multiplied to produce a product (8) that must be kept in mind and added to the number (2) in the Carrying Zone to produce a sum (10). The ones-place digit (0) of that sum is placed in the second column in the Addition Zone, and the tens-place digit (1) of that product is placed in the third column of the Carrying Zone. There are no digits in the third column of the Multiplication Zone, so the tens-place digit (1) placed above that is simply “added” to assumed zeroes in the third column of the Multiplication Zone to produce a sum (1), which is then placed in the third column of the Addition Zone beneath the line to produce the result (104) of the first step of the multiplication.

Next, the tens-place digit (5) of the lower number and the ones-place digit (3) of the upper number are multiplied to produce a product (15). The ones-place digit (5) of the product is then placed in the second column of the Addition Zone below the second digit (0) of the prior number (104) in the Addition Zone. The tens-place digit (1) of the product is then placed in the Carrying Zone above the second column in the Multiplication Zone. At the same time, the prior tens-place digit (2) in the Carrying Zone is crossed out so as not to confuse the new tens-place digit (1) with the prior tens-place digit. Next, the tens-place digit (5) of the lower number and the tens-place digit (1) of the upper number are multiplied to produce a product (5), which when added to the new tens-place digit (1) in the Carrying Zone totals to 6. That result is placed in the third column of the Addition Zone. A line is drawn at the bottom of the Addition Zone, and the numbers in the Addition Zone (104 and 65) are then totaled to produce a total (754), which is then placed in the Answer Zone and represents the solution to the problem of multiplying 13 and 58 using the conventional method of teaching multiplication.

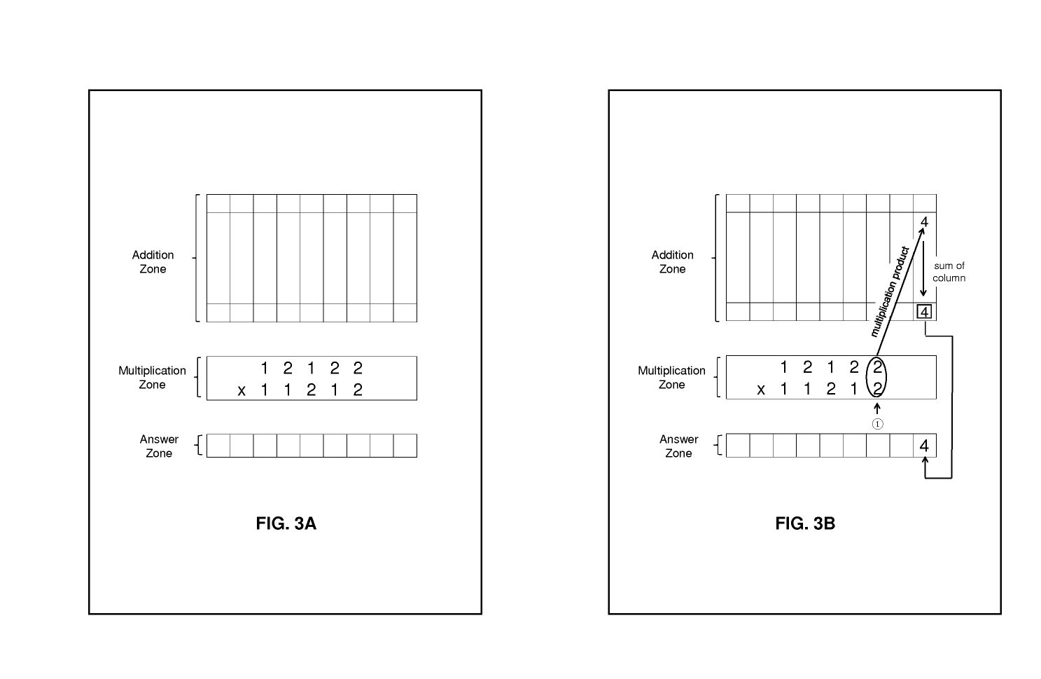

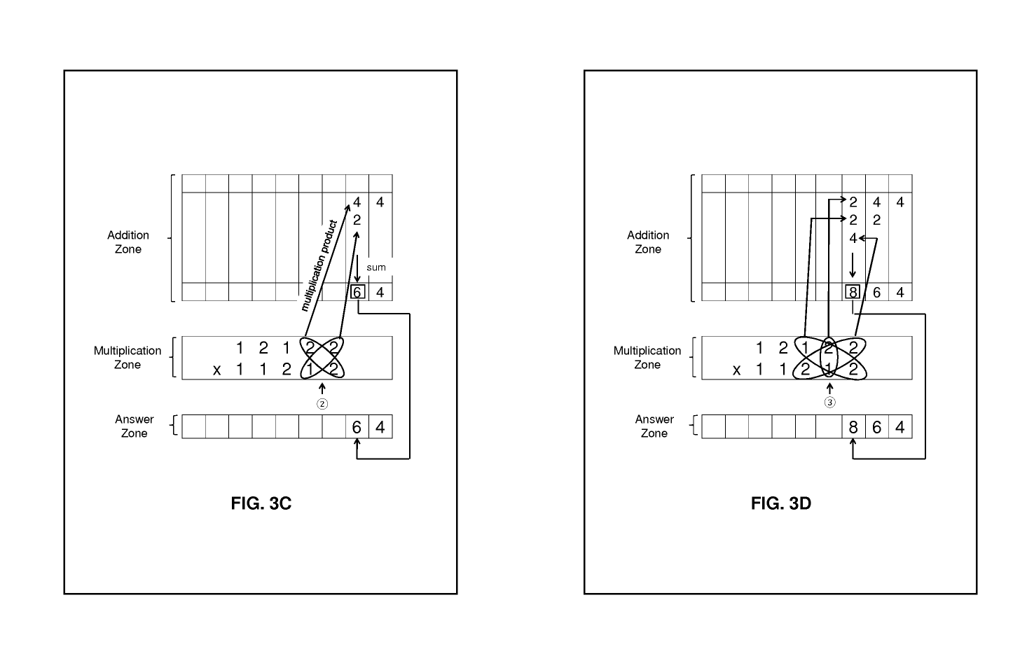

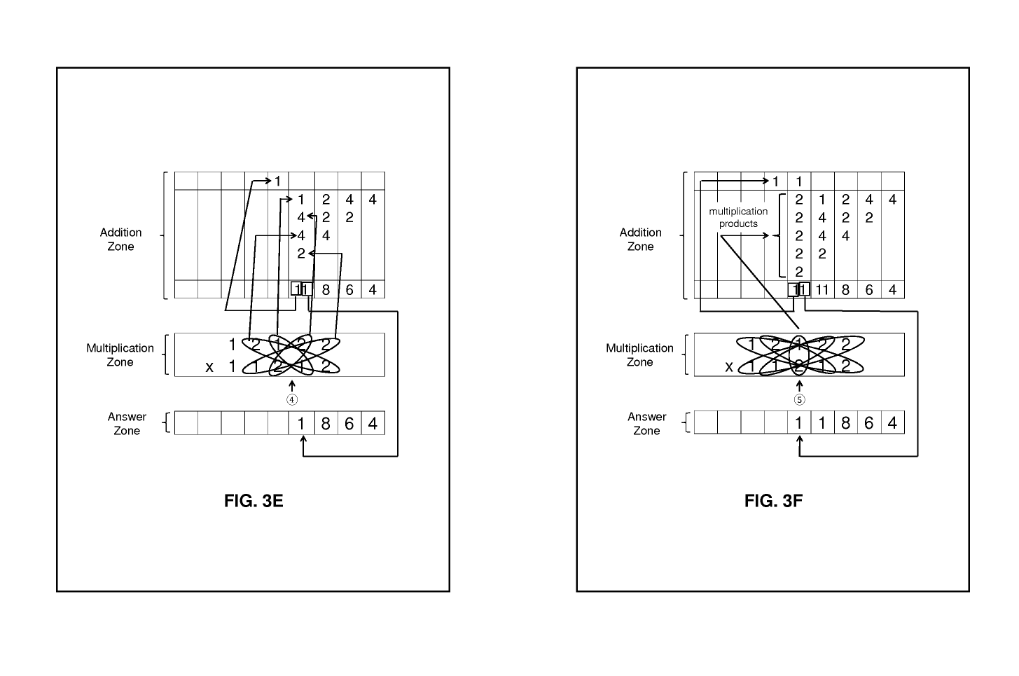

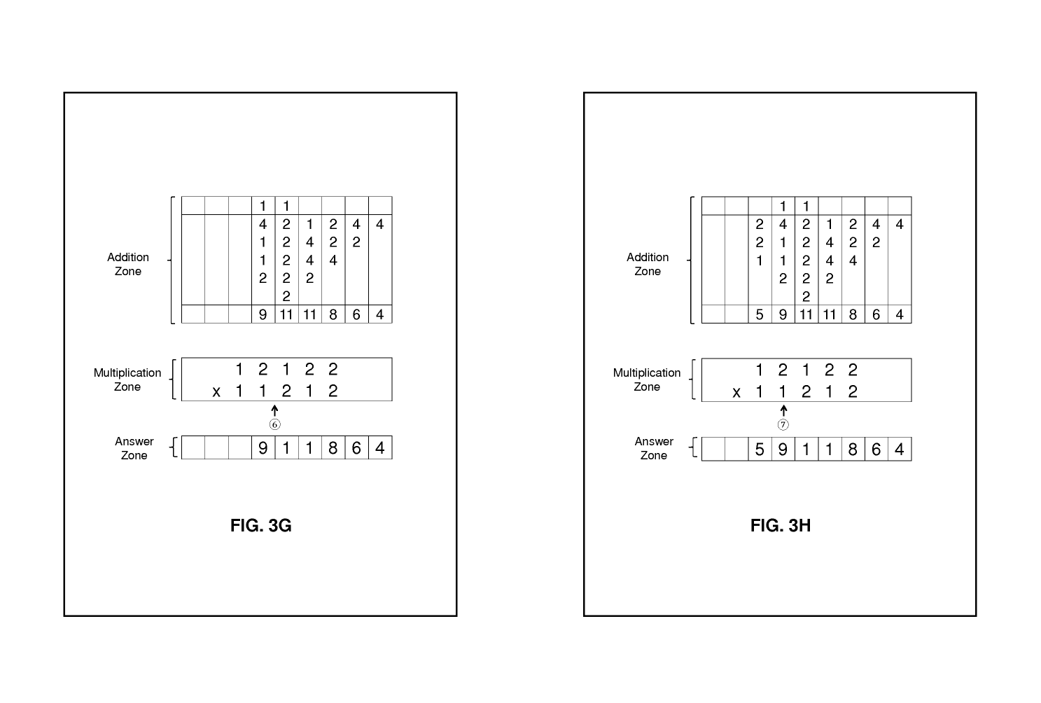

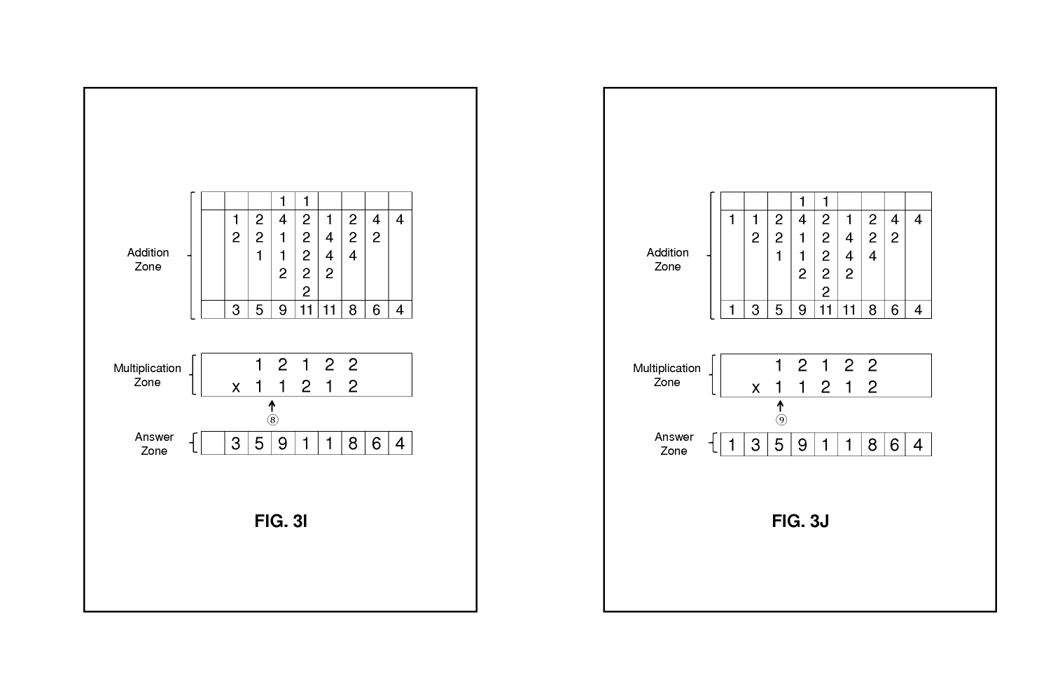

Turning now to FIGS. 3A-3J, the multiplication of two 5-digit numbers (12122 and 11212) will be carried out using the present method of teaching multiplication. At the outset, and as shown in FIG. 3A, three zones are drawn, the first being the Addition Zone containing a top row, a bottom row and enough space for additional rows. The Addition Zone is also divided into a number of columns corresponding to the number of digits in the numbers being multiplied minus one. In the case of the multiplication exercise being commenced in FIG. 3A, there are 10 digits in the numbers being multiplied, so the number of columns in the Addition Zone is 9. Beneath the Addition Zone is the Multiplication Zone, which contains the original numbers to be multiplied. Beneath the Multiplication Zone is the Answer Zone, which consists of one row and, like the Addition Zone, is divided into a number of cells (9) corresponding to the number of digits being multiplied minus one.

FIG. 3B illustrates step \textcircled{1} of the present method. The pivot point is placed below the first column of digits in the Multiplication Zone. The digits in the first (right-most) column (2 and 2) are multiplied, and the product (4) is placed in the first (right-most) column of the Addition Zone. That column is then summed to produce a total (4), which is placed in the bottom row of the Addition Zone. The ones-place digit (4) of the sum is then placed in the first (right-most) cell in the Answer Zone. (As will be illustrated in some of the later steps described below, if the sum had produced a 2-digit number, then the tens-place digit would have been placed in the second cell (first to the left of the right-most column) in the top row of the Addition Zone.)

FIG. 3C illustrates step \textcircled{2} of the present method. As shown, the pivot point is now placed between the first and second columns of digits in the Multiplication Zone in the Multiplication Zone. The digits in the second column (2 and 1) and the digits in the first column (2 and 2) are cross-multiplied, and the respective products (4 and 2) are then placed in the second column of the Addition Zone. The numbers in that column are then added to produce a sum (6), which is placed in the bottom row of the Addition Zone. The ones-place digit (6) is then placed in the second cell in the Answer Zone.

FIG. 3D illustrates step \textcircled{3} of the present method. As shown, the pivot point is now placed below the second column of digits in the Multiplication Zone. The digits in the second column (2 and 1) at the pivot point are multiplied first, and the product (2) is placed in the third column of the Addition Zone. The digits in the column just to the left of the pivot point (1 and 2) and the digits in the column just to the right of the pivot point (2 and 2) are then cross-multiplied, and the respective products (2 and 4) are placed in the third column of the Addition Zone. The numbers in the third column are then added to produce a sum (8), which is placed in the bottom row of the Addition Zone. The ones-place digit (8) is then placed in the third cell of the Answer Zone.

FIG. 3E illustrates step \textcircled{4} of the present method. As shown, the pivot point is now placed between the second and third columns of digits in the Multiplication Zone. The digits in the third column (1 and 2) and the digits in the second column (2 and 1) are cross-multiplied, and the respective products (1 and 4) are then placed in the fourth column of the Addition Zone. As further shown in FIG. 3E, the digits in the fourth column (2 and 1) and digits in the first column (2 and 2) are cross-multiplied, and the respective products (4 and 2) are then placed in the fourth column of the Addition Zone. The numbers in the fourth column are then added to produce a sum (11), which is placed in the bottom row of the Addition Zone. The ones-place digit (1) is then placed in the fourth cell in the Answer Zone, while the tens-place digit (1) is placed in the top row of the fifth column of the Addition Zone, as shown in FIG. 3E.

The cross-multiplication sequence illustrated in FIG. 3E is important to the understanding of the present method of teaching multiplication. The cross-multiplication is carried out on as many columns of digits in the Multiplication Zone as possible on either side of the pivot point until no further cross-multiplications are possible, even though there may be a column remaining on the left or on the right that cannot be paired and therefore cannot participate in the cross-multiplication portion of a step.

FIG. 3F illustrates step \textcircled{5} of the present method. As shown, the pivot point is now placed below the third column of digits in the Multiplication Zone. The digits in the third column (1 and 2) at the pivot point are multiplied first, and the product (2) is placed in the fifth column of the Addition Zone. The digits in the column just to the left of the pivot point (2 and 1) and the digits in the column just to the right of the pivot point (2 and 1) are then cross-multiplied, and the respective products (2 and 2) are also placed in the fifth column of the Addition Zone. There are more cross-multiplications possible to carry out in the Multiplication Zone on either side of the pivot point, and as further shown in FIG. 3F, the digits in the fifth column (1 and 1) and digits in the first column (2 and 2) are cross-multiplied, and the respective products (2 and 2) are then placed in the fourth column of the Addition Zone. The numbers in the fourth column are then added to produce a sum (11), which is placed in the bottom row of the Addition Zone. The ones-place digit (1) is then placed in the fifth cell of the Answer Zone, while the tens-place digit (1) is placed in the top row of the sixth column of the Addition Zone, as shown in FIG. 3F.

FIG. 3G illustrates step \textcircled{6} of the present method. As shown, the pivot point is now placed between the third and fourth columns of digits in the Multiplication Zone. The ellipses that illustrated the various cross-multiplications in the previous figures have been omitted to simplify this and subsequent figures, but the same cross-multiplication process applies. Accordingly, the digits in the fourth column (2 and 1) and the digits in the third column (1 and 2) are cross-multiplied, and the respective products (4 and 1) are then placed in the sixth column of the Addition Zone. The digits in the fifth column (1 and 1) and digits in the second column (2 and 1) are cross-multiplied, and the respective products (1 and 2) are then placed in the sixth column of the Addition Zone. No further cross-multiplications are possible, so the numbers in the sixth column are then added to produce a sum (9), which is placed in the bottom row of the Addition Zone. The ones-place digit (9) is then placed in the sixth cell of the Answer Zone. There is no tens-place digit to be placed in the top row of the seventh column of the Addition Zone in FIG. 3G.

FIG. 3H illustrates step \textcircled{7} of the present method. As shown, the pivot point is now placed below the fifth column of digits in the Multiplication Zone. The digits in the fifth column (2 and 1) at the pivot point are multiplied first, and the product (2) is placed in the seventh column of the Addition Zone. The digits in the column just to the left of the pivot point (1 and 1) and the digits in the column just to the right of the pivot point (1 and 2) are then cross-multiplied, and the respective products (2 and 1) are also placed in the seventh column of the Addition Zone. No further cross-multiplications are possible, so the numbers in the seventh column are then added to produce a sum (5), which is placed in the bottom row of the Addition Zone. The ones-place digit (5) is then placed in the seventh cell of the Answer Zone. There is no tens-place digit to be placed in the top row of the eighth column of the Addition Zone in FIG. 3H.

FIG. 3I illustrates step \textcircled{8} of the present method. As shown, the pivot point is now placed between the fourth and fifth columns of digits in the Multiplication Zone. The digits in the fifth column (1 and 1) and the digits in the fourth column (2 and 1) are cross-multiplied, and the respective products (1 and 2) are then placed in the eighth column of the Addition Zone. No further cross-multiplications are possible, so the numbers in the eighth column are then added to produce a sum (3), which is placed in the bottom row of the Addition Zone. The ones-place digit (3) is then placed in the eighth cell of the Answer Zone. There is no tens-place digit to be placed in the top row of the ninth column of the Addition Zone in FIG. 3I.

FIG. 3J illustrates step \textcircled{9} of the present method. As shown, the pivot point is now placed below the fifth column of digits in the Multiplication Zone. The digits in the fifth column (1 and 1) at the pivot point are multiplied, and the product (1) is placed in the ninth column of the Addition Zone. That column is then summed to produce a total (1), which is placed in the bottom row of the Addition Zone. The ones-place digit (1) is placed in the ninth (left-most) cell of the Answer Zone in FIG. 3J.

The sequence of digits in the Answer Zone of FIG. 3J (135911864) is the solution to the problem of multiplying 12122 and 11212 using the present method of teaching multiplication.

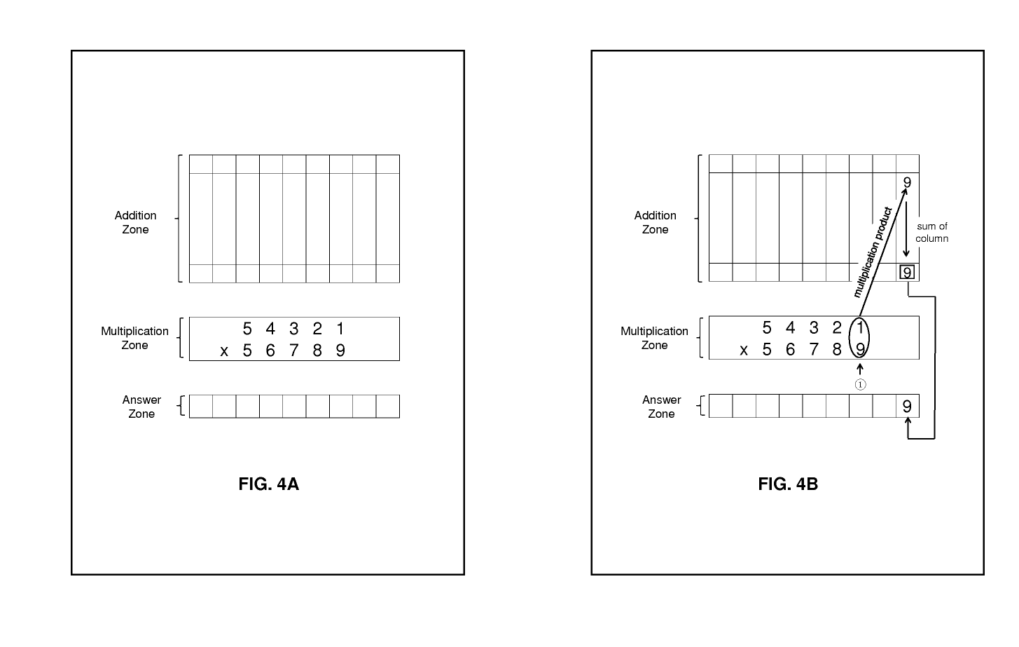

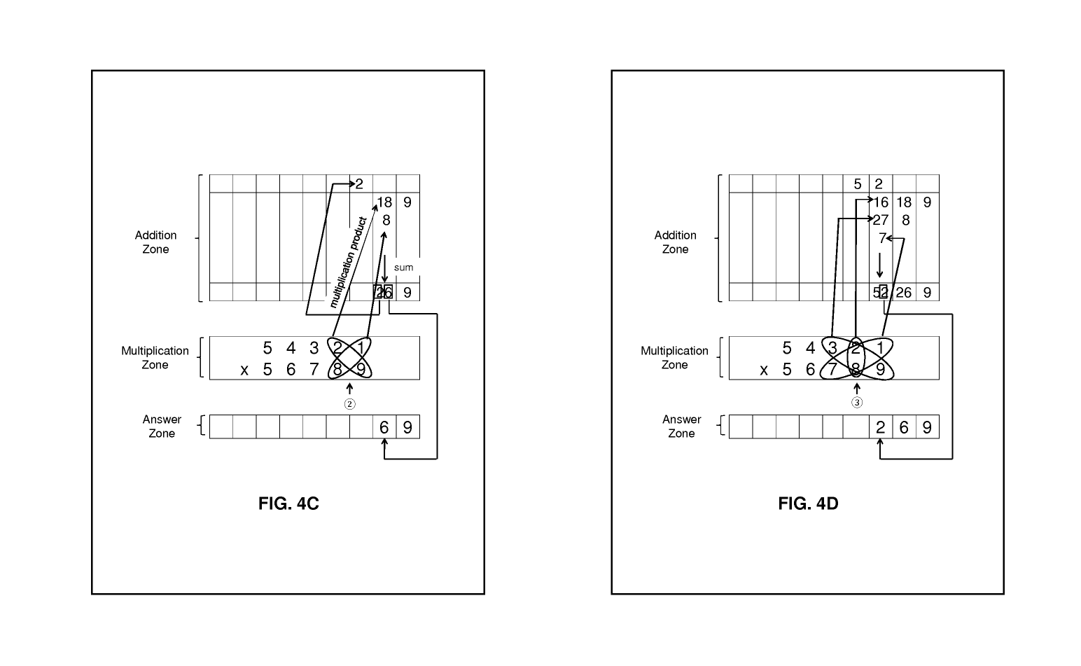

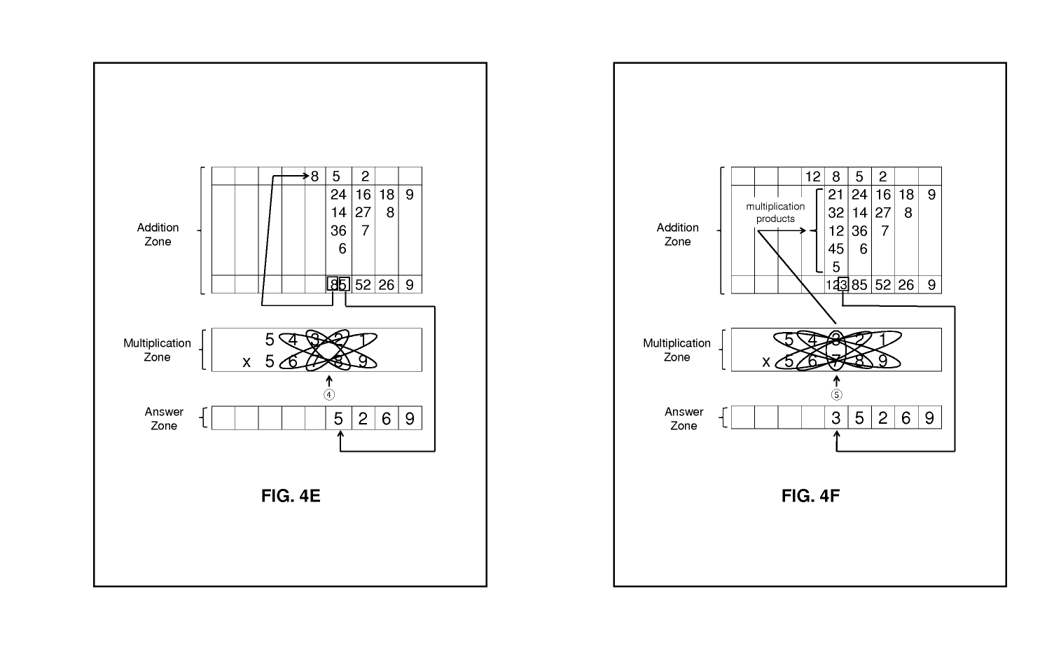

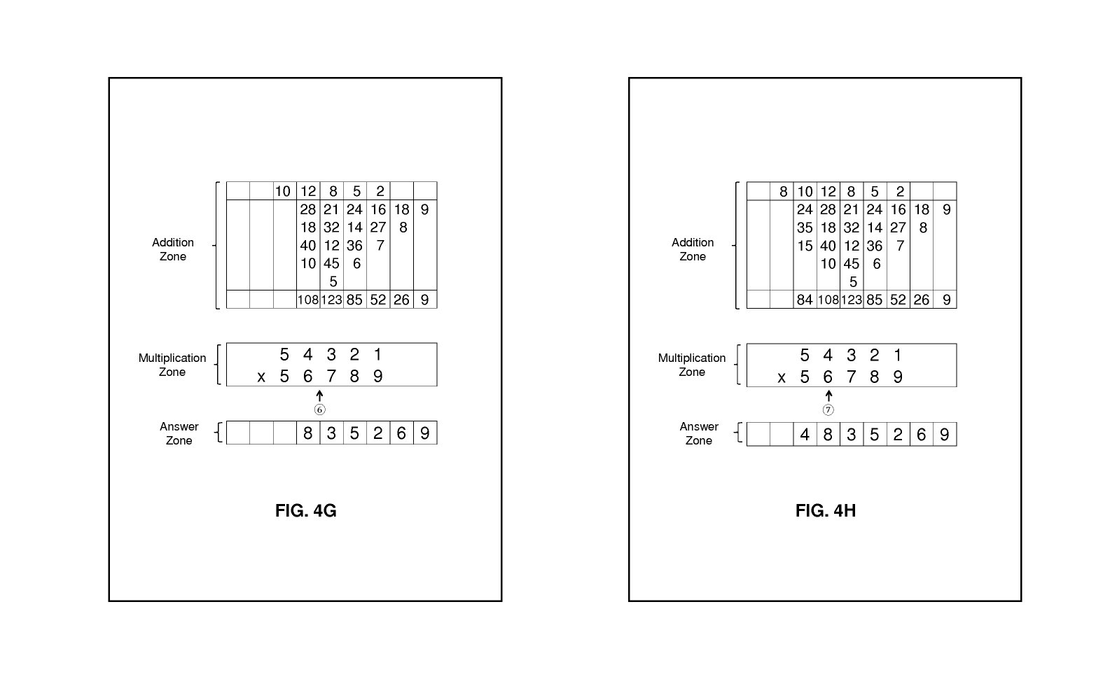

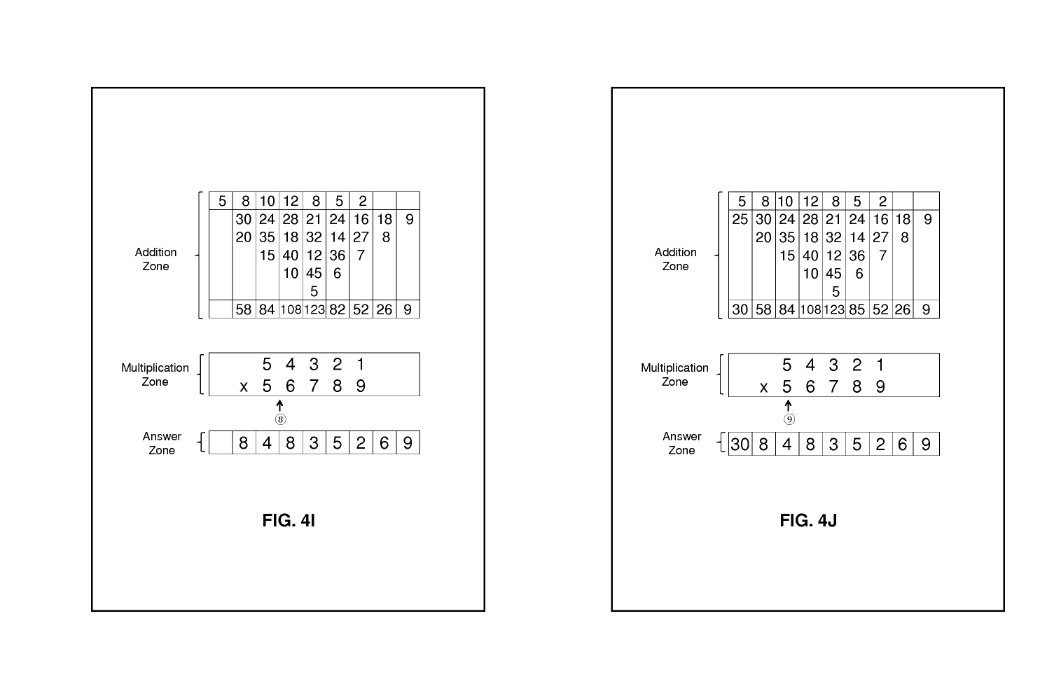

FIGS. 4A-4J illustrate the multiplication of two 5-digit numbers, made up of larger numbers than those in FIGS. 3A-3J, in order to demonstrate the present method using numbers whose products when multiplied are larger double-digit numbers. The 5-digit numbers being multiplied in FIGS. 4A-4J are 54321 and 56789. At the outset, and as shown in FIG. 4A, the Addition Zone, the Multiplication Zone and the Answer Zone are drawn. The Addition Zone contains a top row, a bottom row, enough space for additional rows, and nine columns, which corresponds to the number of digits in the numbers being multiplied minus one. Beneath the Addition Zone is the Multiplication Zone, which contains the original numbers to be multiplied. Beneath the Multiplication Zone is the Answer Zone, which consists of one row and, like the Addition Zone, is divided into 9 columns.

FIG. 4B illustrates step \textcircled{1} of the present method. The pivot point is placed below the first column of digits in the Multiplication Zone to be multiplied. The digits in the first (right-most) column (1 and 9) are multiplied, and the product (9) is placed in the first (right-most) column of the Addition Zone. That column is then summed to produce a total (9), which is placed in the bottom row of the Addition Zone. The ones-place digit (9) is then placed in the first (right-most) cell of the Answer Zone.

FIG. 4C illustrates step \textcircled{2} of the present method. As shown, the pivot point is now placed between the first and second columns of digits in the Multiplication Zone. The digits in the second column (2 and 8) and the digits in the first column (2 and 1) are cross-multiplied, and the respective products (18 and 8) are then placed in the second column of the Addition Zone. The numbers in that column are then added to produce a sum (26), which is placed in the bottom row of the Addition Zone. The ones-place digit (6) is then placed in the second cell of the Answer Zone, while the tens-place digit (2) is placed in the top row of the third column of the Addition Zone in FIG. 4C.

FIG. 4D illustrates step \textcircled{3} of the present method. As shown, the pivot point is now placed below the second column of digits in the Multiplication Zone. The digits in the second column (2 and 8) at the pivot point are multiplied first, and the product (16) is placed in the third column of the Addition Zone. The digits in the column just to the left of the pivot point (3 and 7) and the digits in the column just to the right of the pivot point (1 and 9) are then cross-multiplied, and the respective products (27 and 7) are placed in the third column of the Addition Zone. The numbers in the third column are then added to produce a sum (52), which is placed in the bottom row of the Addition Zone. The ones-place digit (2) is then placed in the third cell of the Answer Zone, while the tens-place digit (5) is placed in the top row of the fourth column of the Addition Zone in FIG. 4D.

FIG. 4E illustrates step \textcircled{4} of the present method. As shown, the pivot point is now placed between the second and third columns of digits in the Multiplication Zone. The digits in the third column (3 and 7) and the digits in the second column (2 and 8) are cross-multiplied, and the respective products (24 and 14) are then placed in the fourth column of the Addition Zone. As further shown in FIG. 4E, the digits in the fourth column (4 and 6) and digits in the first column (1 and 9) are cross-multiplied, and the respective products (36 and 6) are then placed in the fourth column of the Addition Zone. The numbers in the fourth column are then added to produce a sum (85), which is placed in the bottom row of the Addition Zone. The ones-place digit (5) is then placed in the fourth cell of the Answer Zone, while the tens-place digit (8) is placed in the top row of the fifth column of the Addition Zone, as shown in FIG. 4E.

FIG. 4F illustrates step \textcircled{5} of the present method. As shown, the pivot point is now placed below the third column of digits in the Multiplication Zone. The digits in the third column (3 and 7) at the pivot point are multiplied first, and the product (21) is placed in the fifth column of the Addition Zone. The digits in the column just to the left of the pivot point (4 and 6) and the digits in the column just to the right of the pivot point (2 and 8) are then cross-multiplied, and the respective products (32 and 12) are also placed in the fifth column of the Addition Zone. There are more cross-multiplications possible to carry out on either side of the pivot point, and as further shown in FIG. 4F, the digits in the fifth column (5 and 5) and digits in the first column (1 and 9) are cross-multiplied, and the respective products (45 and 5) are then placed in the fourth column of the Addition Zone. The numbers in the fourth column are then added to produce a sum (123), which is placed in the bottom row of the Addition Zone. The ones-place digit (3) is then placed in the fifth cell of the Answer Zone, while the second and hundreds-place digits (12) are together placed in the top row of the sixth column of the Addition Zone, as shown in FIG. 4F.

FIG. 4G illustrates step \textcircled{6} of the present method. As shown, the pivot point is now placed between the third and fourth columns of digits in the Multiplication Zone. The ellipses that illustrated the various cross-multiplications in the previous figures have been omitted to simplify this and subsequent figures, but the same cross-multiplication process applies. Accordingly, the digits in the fourth column (4 and 6) and the digits in the third column (3 and 7) are cross-multiplied, and the respective products (28 and 18) are then placed in the sixth column of the Addition Zone. The digits in the fifth column (5 and 5) and digits in the second column (2 and 8) are cross-multiplied, and the respective products (40 and 10) are then placed in the sixth column of the Addition Zone. No further cross-multiplications are possible, so the numbers in the sixth column are then added to produce a sum (108), which is placed in the bottom row of the Addition Zone. The ones-place digit (8) is then placed in the sixth cell of the Answer Zone, while the second and hundreds-place digits (10) are together placed in the top row of the seventh column of the Addition Zone, as shown in FIG. 4G.

FIG. 4H illustrates step \textcircled{7} of the present method. As shown, the pivot point is now placed below the fifth column of digits in the Multiplication Zone. The digits in the fifth column (4 and 6) at the pivot point are multiplied first, and the product (24) is placed in the seventh column of the Addition Zone. The digits in the column just to the left of the pivot point (5 and 5) and the digits in the column just to the right of the pivot point (3 and 7) are then cross-multiplied, and the respective products (35 and 15) are also placed in the seventh column of the Addition Zone. No further cross-multiplications are possible, so the numbers in the seventh column are then added to produce a sum (84), which is placed in the bottom row of the Addition Zone. The ones-place digit (4) is then placed in the seventh cell of the Answer Zone, while the tens-place digit (8) is placed in the top row of the eighth column of the Addition Zone in FIG. 4H.

FIG. 4I illustrates step \textcircled{8} of the present method. As shown, the pivot point is now placed between the fourth and fifth columns of digits in the Multiplication Zone. The digits in the fifth column (5 and 5) and the digits in the fourth column (4 and 6) are cross-multiplied, and the respective products (30 and 20) are then placed in the eighth column of the Addition Zone. No further cross-multiplications are possible, so the numbers in the eighth column are then added to produce a sum (58), which is placed in the bottom row of the Addition Zone. The ones-place digit (8) is then placed in the eighth cell of the Answer Zone, while the tens-place digit (5) is placed in the top row of the ninth column of the Addition Zone in FIG. 4I.

FIG. 4J illustrates step \textcircled{9} of the present method. As shown, the pivot point is now placed below the fifth column of digits in the Multiplication Zone. The digits in the fifth column (5 and 5) at the pivot point are multiplied, and the product (25) is placed in the ninth column of the Addition Zone. No cross-multiplications are possible to perform, so that column is then summed to produce a total (30), which is placed in the bottom row of the Addition Zone and which is also placed in the ninth (left-most) cell of the Answer Zone.

The sequence of digits in the Answer Zone of FIG. 4J (3084835269) is the solution to the problem of multiplying 54321 and 56789 using the present method of teaching multiplication.

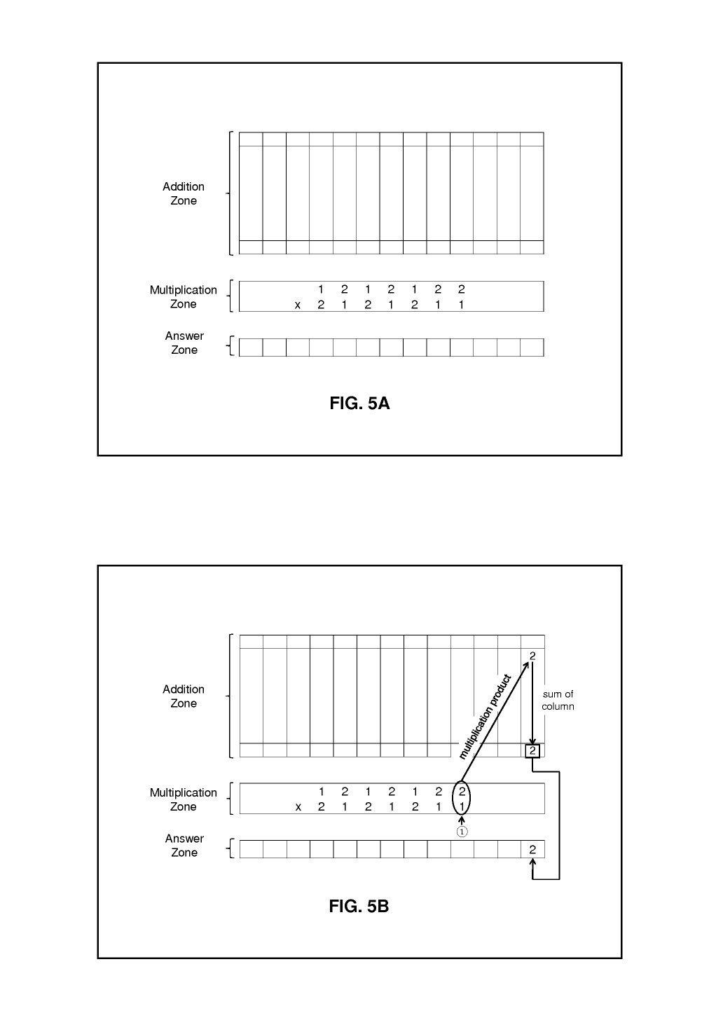

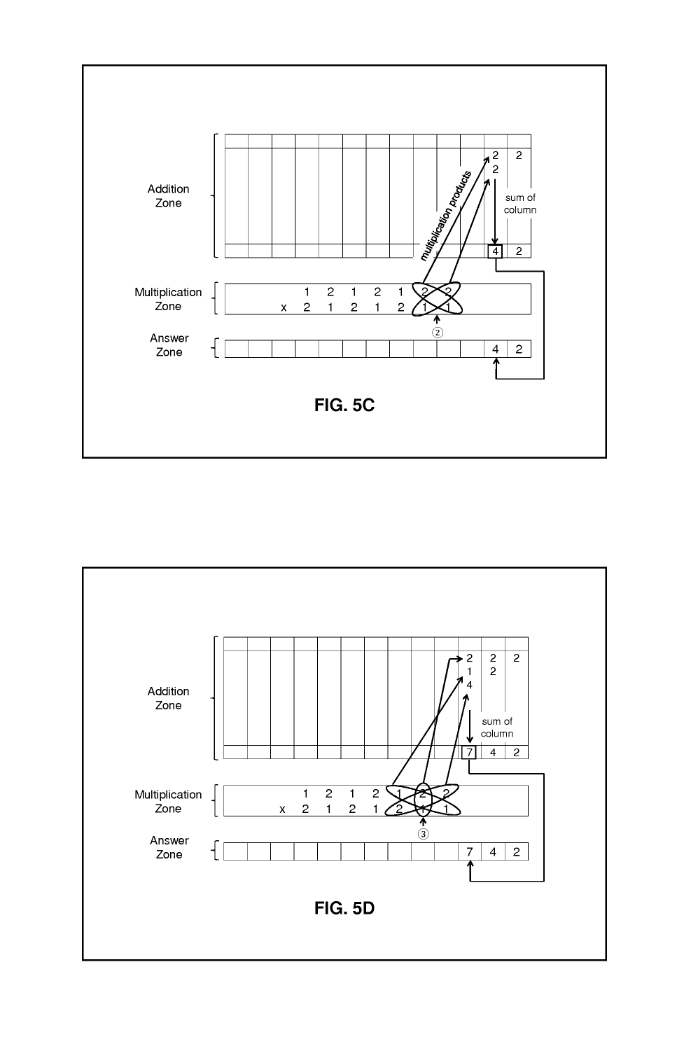

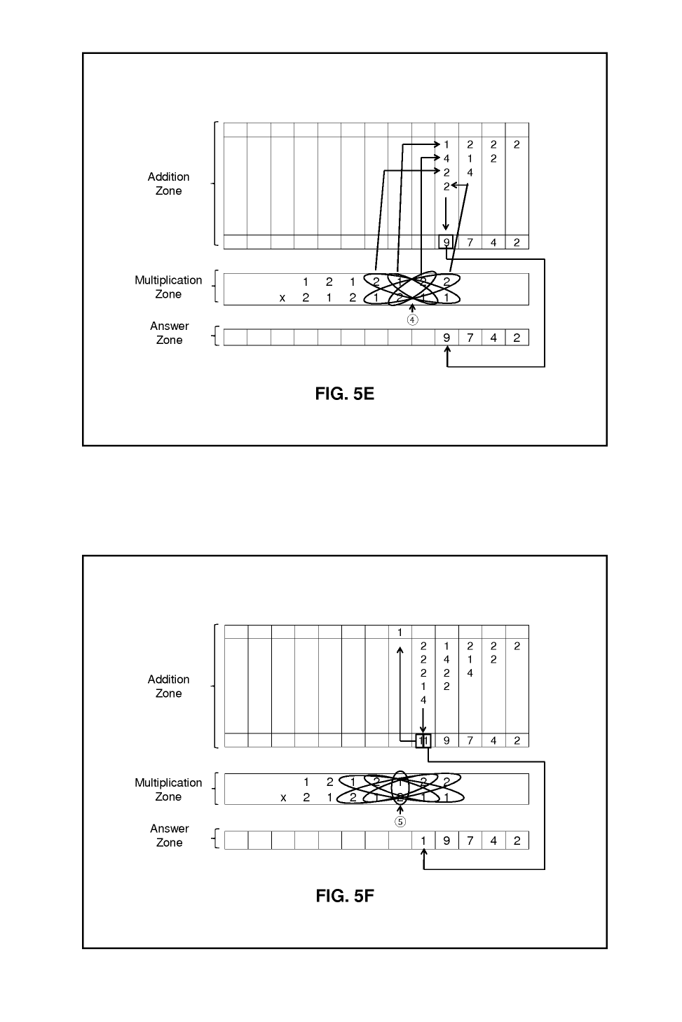

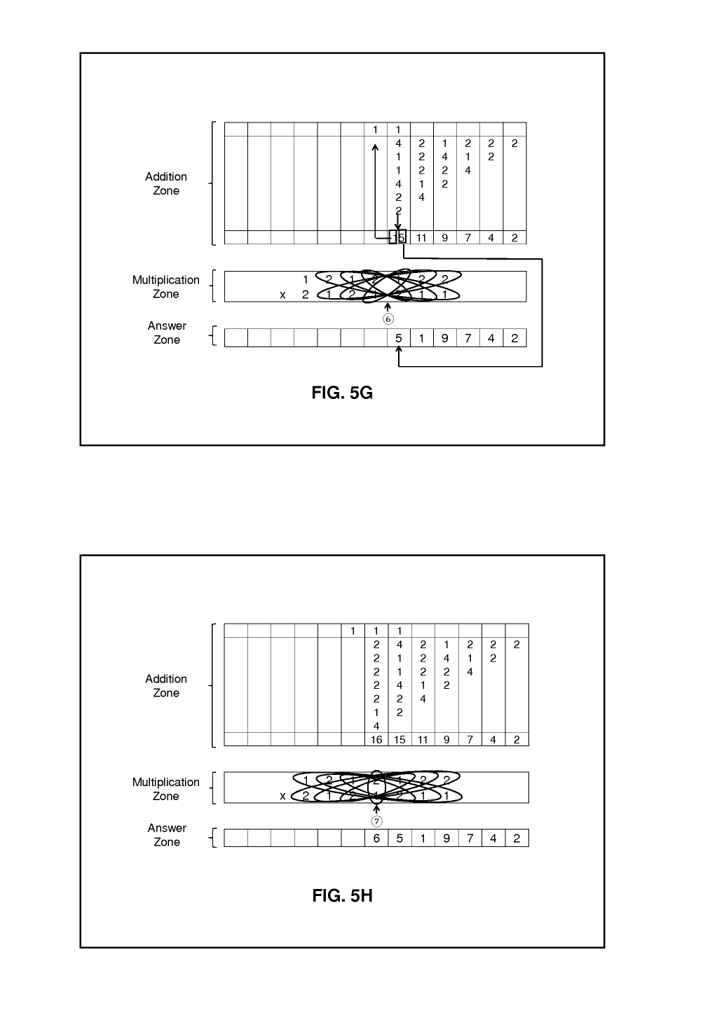

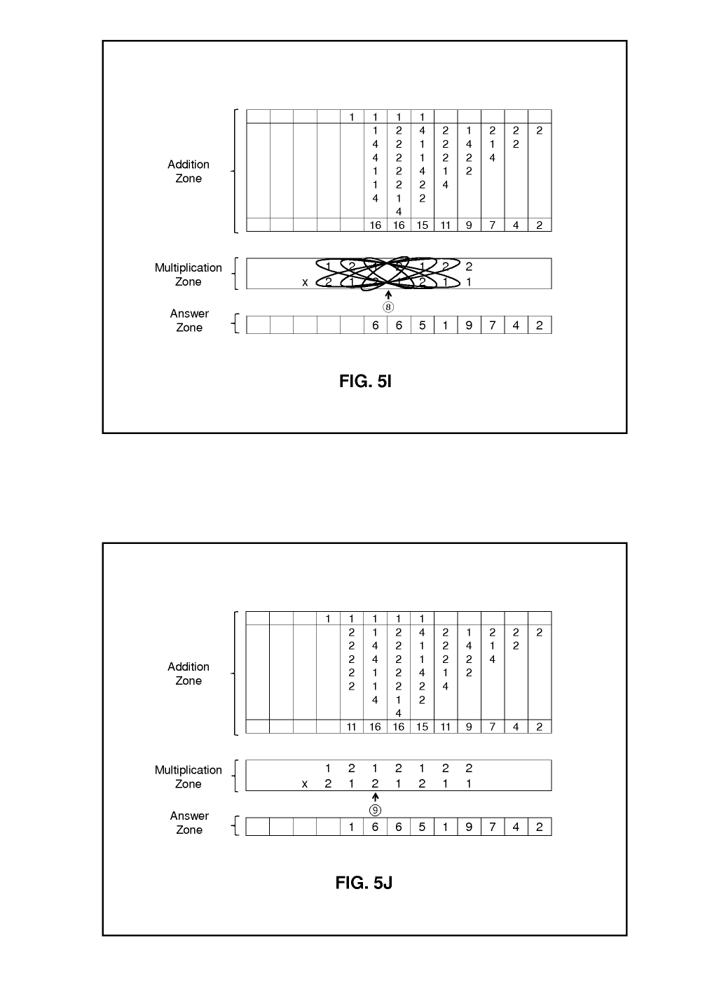

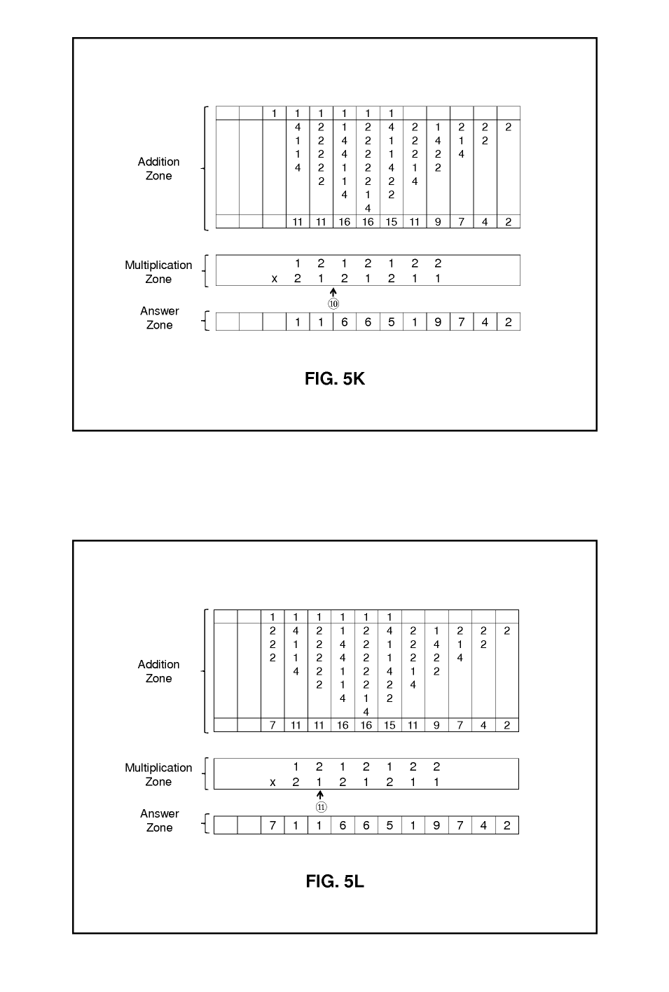

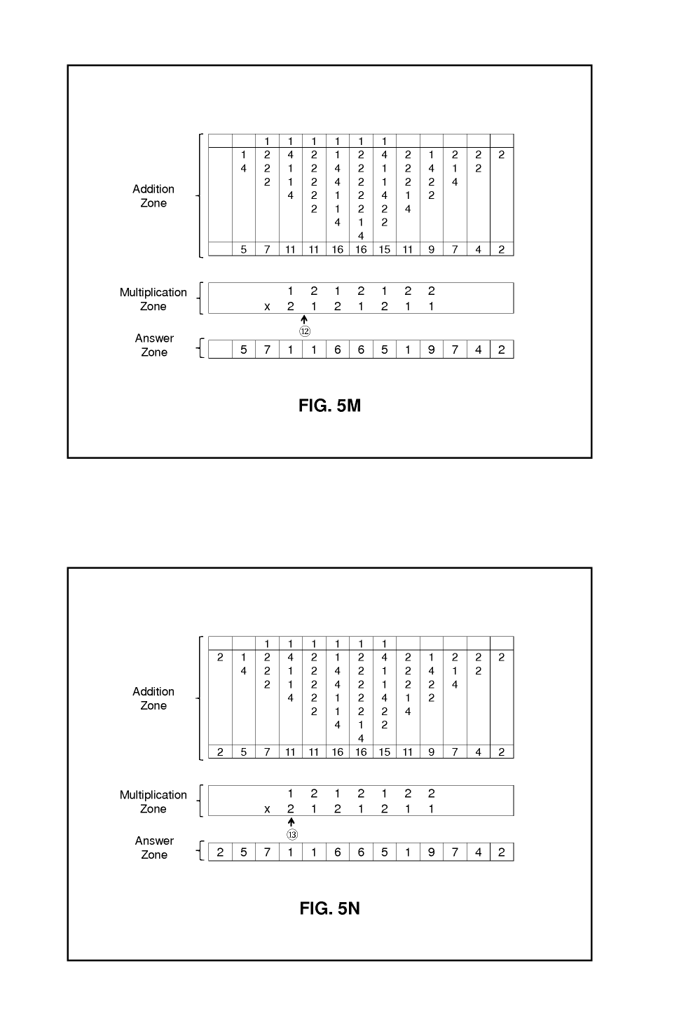

FIGS. 5A-5N are diagrams showing the progression of steps involved in the present method of teaching the multiplication of two 7-digit numbers (1212122 and 2121211). For brevity, the steps associated with that multiplication exercise will not be described in this text, since the steps are substantially similar to those carried out in the multiplication exercises illustrated in FIGS. 3A-3J and FIGS. 4A-4J, and can be readily understood with reference to FIGS. 5A-5N after having understood the previous figures and accompanying text.

In the present method, where the numbers to be multiplied are of different length, then the smaller number should be preceded by zeroes such that both numbers are of the same length when arranged in the Multiplication Zone. For example, to multiply 78923 with 4567, the numbers should be arranged in the Multiplication Zone as:

$$\begin{matrix}Multiplication \\ Zone\end{matrix} \{ \begin{matrix} & 7 & 8 & 9 & 2 & 3 \\ \times & 0 & 4 & 5 & 6 & 7\end{matrix}$$

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A method of teaching multiplication to mathematics students, the method comprising the steps of:
(a) providing a pair of multi-digit numbers to be multiplied;
(b) diagrammatically arranging the numbers on a work area comprising:
(1) a Multiplication Zone comprising the numbers arranged such that the digits of one number are vertically aligned with the digits of the other number;
(2) an Addition Zone comprising a top row, a bottom row and a plurality of middle rows, the rows divided into a number of columns corresponding to the sum of the number of digits in the numbers to be multiplied minus one;
(3) an Answer Zone comprising a row divided into a number of cells corresponding to the sum of the number of digits in the numbers to be multiplied minus one;
(c) establishing a pivot point beneath the aligned lowest place digits;
(d) multiplying the aligned lowest place digits and cross-multiplying the aligned digits on either side of the pivot point progressively in pairs until no further pairs can be formed;
(e) placing the products of multiplication step (d) in the middle rows of the right-most empty column of the Addition Zone;
(f) adding together the products placed in the column of step (e) and placing the sum in the right-most empty cell in the bottom row of the Addition Zone;
(g) placing the lowest place digit of the sum in step (f) in the right-most empty cell of the Answer Zone and placing the higher place digits of the sum in step (f) in the next cell to the left in the top row of the Addition Zone;
(h) establishing a next pivot point between the aligned lowest and next-lowest place digits;
(i) cross-multiplying the aligned digits on either side of the pivot point progressively in pairs until no further pairs can be formed;
(j) placing the product of the cross-multiplication step (i) in the middle rows of the right-most empty column of the Addition Zone;
(k) adding together the products placed in the column of step (j) and placing the sum in the right-most empty cell in the bottom row of the Addition Zone;
(l) placing the lowest place digit of the sum in step (k) in the right-most empty cell of the Answer Zone and placing the higher place digits of the sum in step (k) in the next cell to the left in the top row of the Addition Zone;
(m) repeating steps (c) through (l) until the left-most aligned digits have been multiplied;
whereby the sequence of digits in the Answer Zone is the product of the multiplication of the pair of multi-digit numbers.

2. The method of claim 1, wherein multi-digit numbers of different length are made equal in length by preceding the smaller number with zeroes.

3. A diagrammatic work area for teaching multiplication to mathematics students, the work area comprising:
(a) a Multiplication Zone comprising a pair of multi-digit numbers to be multiplied arranged such that the digits of one number are vertically aligned with the digits of the other number;
(b) an Addition Zone comprising a top row, a bottom row and a plurality of middle rows, the rows divided into a number of columns corresponding to the sum of the number of digits in the numbers to be multiplied minus one;
(c) an Answer Zone comprising a row divided into a number of cells corresponding to the sum of the number of digits in the numbers to be multiplied minus one;
whereby:
(1) each of the products of multiplication and cross-multiplication of the aligned digits can be placed in a designated column in the middle rows of the Addition Zone;
(2) each of the sums resulting from the addition of the products in the columns can be placed in a right-most empty cell of the bottom row of the Addition Zone;
(3) each of the lowest place digits of the sums can be placed in a right-most empty cell of the Answer Zone and each of the higher place digits of the sums can be placed in the next cell to the left in the top row of the Addition Zone; and
(4) the sequence of digits in the Answer Zone is the product of the multiplication of the pair of multi-digit numbers.
